(19) United States
(12) Patent Application Publication
(10) Pub. No.: US 2026/0342738 A1
(43) Pub. Date: Oct. 29, 2026

(54) MACHINE LEARNING BASED AUTOMATED RESOURCE SHARING IN INFORMATION TECHNOLOGY INFRASTRUCTURE

(71) Applicant: Dell Products L.P., Round Rock, TX (US)

(72) Inventors: Ritesh Anand, Pune (IN); Abhishek Mishra, Bangalore (IN); Abhishek Koushik B N, Bangalore (IN)

(21) Appl. No.: 19/192,497

(22) Filed: Apr. 29, 2025

(51) Int. Cl. H04L 47/78; H04L 47/83

(52) U.S. Cl. CPC H04L 47/781; H04L 47/83

(57) ABSTRACT

An apparatus in one embodiment is configured to maintain one or more data structures characterizing utilization of cloud resources in information technology infrastructure of an enterprise, the cloud resources being part of at least first and second cloud systems of respective first and second different types and being allocated to one or more users within the enterprise. The apparatus applies at least portions of the one or more data structures to one or more machine learning models to generate one or more predictions relating to future utilization of the cloud resources by the one or more users, and automatically controls movement of at least portions of the cloud resources into and out of a shared resource pool of the enterprise based at least in part on the one or more predictions, wherein the cloud resources of the shared resource pool are subject to allocation to additional users within the enterprise.

### FIELD

The field relates generally to information processing systems, and more particularly to machine learning in information processing systems.

### BACKGROUND

In today's rapidly evolving technology landscape, cloud computing and storage plays a crucial role in providing scalable and flexible information technology (IT) infrastructure for a wide variety of different organizations and other enterprises. Typically, users within a given enterprise subscribe to cloud plans that suit their particular needs. However, despite the inherent flexibility of cloud systems, underutilization of allocated cloud resources remains a significant challenge. For example, many cloud resources, including storage and virtual machines, often operate below their optimal capacity or are otherwise overprovisioned, resulting in wasted resources and increased costs.

### SUMMARY

Illustrative embodiments of the present disclosure provide techniques for machine learning based automated resource sharing in information processing systems comprising IT infrastructure of various types, such as public clouds, private clouds and/or data centers.

For example, some embodiments address the above-described drawbacks of conventional approaches at least in part by providing a centralized hub, more generally referred to herein as a “pool hub,” to provide machine learning based sharing of resources, such as compute, storage and/or network resources in IT infrastructure of an organization or other enterprise. The resources in some embodiments are illustratively pooled across different cloud environments of different types, including public clouds, private clouds and on-premises data centers, and possibly additional or alternative cloud systems.

The pool hub in some embodiments leverages the pooled resources for improved utilization of those resources across the enterprise. Moreover, the pool hub provides a resource reuse arrangement, in which resources initially allocated for certain users can be returned to the resource pool for future utilization by other users. Such an arrangement illustratively involves pooling resources from existing unused capacity rather than obtaining and allocating new resources for each enterprise user.

These and other arrangements disclosed herein can substantially improve overall resource utilization and associated productivity in an organization or other enterprise that encompasses a combination of different types of IT infrastructure, such as public clouds, private clouds and on-premises data centers. In addition, such arrangements can significantly reduce resource wastage and enterprise costs, for example, by more fully utilizing existing cloud plans before initiating additional cloud plans for enterprise users.

In one embodiment, an apparatus comprises at least one processing device that includes a processor coupled to a memory. The at least one processing device is configured to maintain one or more data structures characterizing utilization of cloud resources in IT infrastructure of an enterprise, the cloud resources being part of at least first and second cloud systems of respective first and second different types and being allocated to one or more users within the enterprise. The at least one processing device is further configured to apply at least portions of the one or more data structures to one or more machine learning models to generate one or more predictions relating to future utilization of the cloud resources by the one or more users. The at least one processing device is still further configured to automatically control movement of at least portions of the cloud resources into and out of a shared resource pool of the enterprise based at least in part on the one or more predictions, wherein the cloud resources of the shared resource pool are subject to allocation to additional users within the enterprise.

In some embodiments, automatically controlling movement of at least portions of the cloud resources into and out of a shared resource pool of the enterprise further comprises pushing a first portion of the cloud resources into a pool hub providing the shared resource pool responsive to monitored utilization of the cloud resources by at least one of the users being below a first threshold, and pulling a second portion of the cloud resources out of a pool hub providing the shared resource pool responsive to monitored utilization of the cloud resources by at least one of the users being above a second threshold.

At least one of the first and second thresholds is illustratively established for a given one of the users based at least in part on a current value of a dynamic minimum set of resources determined for the given user, wherein the dynamic minimum set of resources is determined for the given user at least in part from the one or more predictions generated by the one or more machine learning models.

Additionally or alternatively, a dynamic minimum set of resources is illustratively determined for each of at least a subset of the users within the enterprise. In one or more such embodiments, automatically controlling movement of at least portions of the cloud resources into and out of the shared resource pool of the enterprise illustratively comprises automatically controlling movement of at least portions of the cloud resources into and out of the shared resource pool based at least in part on the dynamic minimum set of resources determined for each of at least a subset of the users.

Such features of illustrative embodiments are examples only, and should not be viewed as limiting in any way.

These and other illustrative embodiments include, without limitation, additional apparatus, as well as methods, systems and computer program products comprising processor-readable storage media.

### BRIEF DESCRIPTION OF THE DRAWINGS

FIG. 1 is a block diagram of an information processing system configured for machine learning based automated resource sharing in an illustrative embodiment.

FIG. 2 is a flow diagram of an example process for machine learning based automated resource sharing in an illustrative embodiment.

FIG. 3 is a block diagram of another information processing system configured for machine learning based automated resource sharing in an illustrative embodiment.

FIG. 4 is a combined block diagram and flow diagram showing example operations performed in implementing machine learning based resource sharing in an illustrative embodiment.

FIG. 5 shows an example of an automated algorithm for machine learning based automated resource sharing in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices, in various arrangements of IT infrastructure. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center and/or other types of cloud-based systems, such as at least one cloud-based system that includes one or more public, private and/or hybrid clouds each hosting one or more tenants or other system users that access cloud resources.

As indicated above, illustrative embodiments provide techniques for optimizing resource utilization, illustratively through a pool hub that implements an automated resource sharing mechanism for one or more enterprises.

In typical current cloud systems, whether including an on-premises, pure cloud, hybrid, and/or multi-cloud environment, different teams of users within a given enterprise often create separate databases (DBs) with varying resource allocations, such as particular numbers of virtual machines (VMs) and associated storage resource configurations. Each such team typically pays a fixed amount based on their chosen VM and storage configuration, as per the current cloud pricing structure. Such conventional arrangements lead to the above-noted problem of underutilization of resources, as many cloud resources, including VMs and associated storage resources, often operate below their optimal capacity or are otherwise overprovisioned, resulting in wasted resources and increased costs.

Illustrative embodiments disclosed herein advantageously allow organizations and other enterprises to avoid these and other unnecessary costs, for example, by leveraging the above-noted shared resource pool as disclosed herein. For example, when resource needs of a given enterprise user are met using a portion of an original resource, remaining portions of the original resource become part of the shared resource pool and may be allocated via the pool hub to the same or other enterprise users throughout the tenure for which the original resource was provisioned. The shared resource pool saves costs by ensuring that users are utilizing only their required resources, such as particular amounts of storage and compute resources, while additional allocated resources of those users are pooled for use by additional users of the enterprise. Similar advantages are provided in these and other embodiments, possibly involving additional or alternative types of resources, such as network resources.

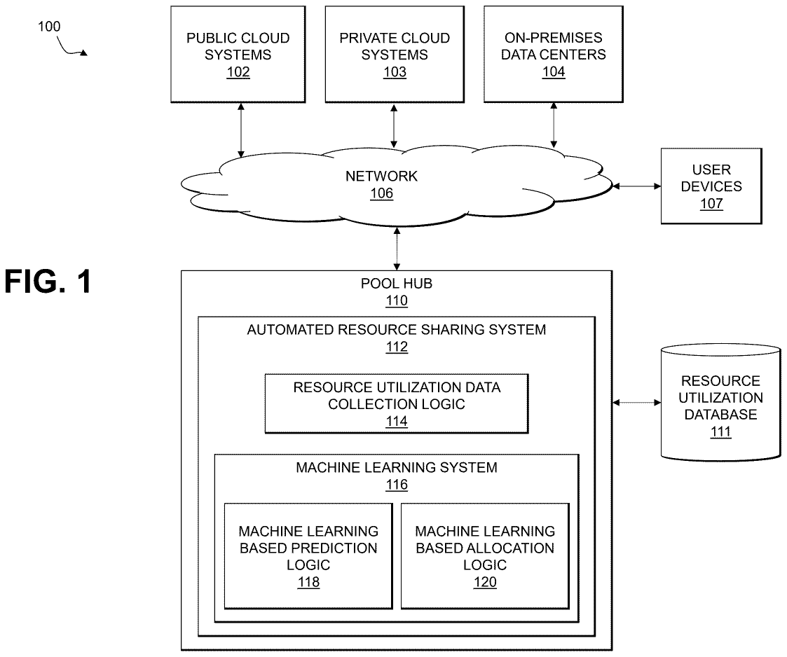

FIG. 1 shows an information processing system 100 configured in accordance with an illustrative embodiment. The information processing system 100 is assumed to be built on at least one processing platform and provides functionality for machine learning based automated resource sharing in IT infrastructure as disclosed herein. The information processing system 100 includes one or more public cloud systems 102, one or more private cloud systems 103, and one or more on-premises data centers 104, all coupled to a network 106. Also coupled to the network 106 in the system 100 are one or more sets of user devices 107, and a pool hub 110 that has access to a resource utilization database 111.

The public cloud systems 102, private cloud systems 103, and on-premises data centers 104 are examples of what are more generally referred to herein as “cloud systems.” In some embodiments, the system 100 is configured by a given organization or other enterprise, and one or more of its users are allocated particular cloud resources of the public cloud systems 102, private cloud systems 103, and on-premises data centers 104 for their utilization in carrying out various computation and storage workloads of the enterprise.

The public cloud systems 102 in some embodiments are provided by respective cloud providers that are separate from the enterprise, as respective services fully managed by the cloud providers, while the private cloud systems 103 are illustratively provided and managed by the enterprise itself. Other types of cloud systems can be used, including hybrid clouds that comprise various combinations of public and private clouds.

Also, a “user” as the term is broadly used herein is not limited to a human user, such as an enterprise team member or a group of such team members, but can additionally or alternatively include, for example, automated entities of various types, such as hardware and/or software devices of the system 100, as well as other system components. The term “user” herein is therefore intended to be broadly construed, and a given such user can encompass, for example, multiple human users, as in the case of an enterprise team, and/or at least portions of one or more associated processing devices, such as user devices 107. References herein to users that are “within” an enterprise are similarly intended to be broadly construed, so as to encompass, for example, users that may be physically located external to one or more premises of the enterprise, but are nonetheless employed by or otherwise associated with the enterprise. Users within an enterprise can therefore comprise, for example, employees of the enterprise, regardless of where those users are physically located.

The pool hub 110 in the FIG. 1 embodiment is configured to provide automated resource sharing services for the users of the system 100, which as indicated above illustratively include enterprise users of a given enterprise, such as a company or other organization. Such automated resource sharing services illustratively include machine learning based automated resource sharing techniques as disclosed herein, which in some embodiments relate to resources of one of more of the public cloud systems 102, the private cloud systems 103 and the on-premises data centers 104, although it is to be appreciated that a wide variety of other types of resource sharing services can be provided via pool hub 110 using additional or alternative arrangements of IT infrastructure in other embodiments.

The pool hub 110 illustratively comprises an automated resource sharing system 112 that is configured to provide machine learning based automated resource sharing in the system 100. The automated resource sharing system 112 of pool hub 110 as shown in FIG. 1 comprises resource utilization data collection logic 114 and a machine learning system 116. The machine learning system 116 illustratively comprises machine learning based prediction logic 118 and machine learning based allocation logic 120.

The machine learning based prediction logic 118 and the machine learning based allocation logic 120 are each assumed to include or to otherwise have access to one or more machine learning models. For example, each of the machine learning based prediction logic 118 and the machine learning based allocation logic 120 may be configured to access one or more machine learning models that are internal to the pool hub 110 and/or one or more machine learning models that are external to the pool hub 110. The term “machine learning model” as used herein is intended to be broadly construed, and in some embodiments can comprise a combination of multiple distinct machine learning models of different types. Accordingly, some embodiments can be configured to utilize a single composite machine learning model that includes multiple distinct component machine learning models, each configured to implement different types of machine learning functionality within the pool hub 110.

In some embodiments, the system 100 is implemented utilizing one or more processing platforms each comprising multiple networked processing devices, where the term “processing device” as used herein is intended to be broadly construed so as to encompass, for example, computers, servers, switches, storage arrays and/or other processing devices that may be interconnected or otherwise networked with one another within a given information processing system. Such processing devices illustratively comprise various arrangements of hardware processors that execute software programs stored in associated memory in order to implement at least portions of the disclosed functionality. For example, separate processing platforms may be used to implement each of the public cloud systems 102, the private cloud systems 103, the on-premises data centers 104 and the pool hub 110.

The user devices 107 may comprise, for example, physical computing devices such as mobile telephones, laptop computers, tablet computers, desktop computers or other types of processing devices, in any combination, that may be utilized by members of an enterprise or other users operating or otherwise associated with the IT infrastructure. At least portions of the user devices 107 may be implemented utilizing virtualized computing resources, such as VMs, containers, etc.

As indicated above, the term “user” herein is intended to be broadly construed so as to encompass numerous arrangements of human, hardware, software or firmware entities, as well as combinations of such entities.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The resource utilization database 111 is configured to store information that is used by the automated resource sharing system 112 in conjunction with machine learning operations of the pool hub 110. This information illustratively comprises data records, tables or other types of data structures containing details of resource utilization by users of the system 100. Such information in some embodiments can be obtained at least in part from the public cloud systems 102, the private cloud systems 103 and/or the on-premises data centers 104. In some embodiments, the resource utilization database 111 may be implemented at least in part within the pool hub 110 or another system component.

The resource utilization database 111 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

In some embodiments, such storage systems utilized to implement the resource utilization database 111 can be considered part of one or more of the public cloud systems 102, private cloud systems 103 and/or on-premises data centers 104.

Alternatively, although shown as separate from pool hub 110 in the figure, the resource utilization database 111 and its associated storage system can in some embodiments be implemented at least in part within the pool hub 110.

In operation, the automated resource sharing system 112 of the pool hub 110 is configured to maintain one or more data structures characterizing utilization of cloud resources in IT infrastructure of an enterprise. The cloud resources are assumed to be part of at least first and second cloud systems of respective first and second different types, and allocated to one or more users within the enterprise.

The data structures may comprise, for example, data records, tables or other structured arrangements of data, although the term “data structure” as used herein is intended to be broadly construed, and should not be viewed as being limited to these or any other particular types of data structures. A given data structure as that term is broadly used herein can comprise, for example, a portion of a larger data structure or a combination of multiple smaller data structures.

Such data structures are illustratively stored at least in part in the resource utilization database 111, but can additionally or alternatively be stored at least in part in one or more memories or other storage devices of the pool hub 110, and/or in one or more of the public cloud systems, the private cloud systems 103 and the on-premises data centers 104. Other types and arrangements of data structures can be used in other embodiments.

The data structures are illustratively maintained at least in part under the control of the resource utilization data collection logic 114 of the automated resource sharing system 112. For example, the resource utilization data collection logic 114 is configured in some embodiments to collect resource utilization data, relating to resource utilization of one or more enterprise users, from the public cloud systems 102, the private cloud systems 103 and the on-premises data centers 104 that include the utilized resources, and to populate one or more data structures with the collected data.

The automated resource sharing system 112 is further configured to apply at least portions of the one or more data structures to one or more machine learning models of machine learning system 116 to generate one or more predictions relating to future utilization of the cloud resources by the one or more users, and to automatically control movement of at least portions of the cloud resources into and out of a shared resource pool of the enterprise based at least in part on the one or more predictions. The cloud resources of the shared resource pool are then subject to allocation to additional users within the enterprise.

The above-noted “portions” of the one or more data structures illustratively comprise resource utilization data stored in the data structures and/or processed versions of such data. The term “at least a portion of a data structure” as used herein is therefore intended to be broadly construed.

In some embodiments, the one or more machine learning models of the machine learning system 116 illustratively comprise at least one recurrent neural network (RNN) model configured to generate the one or more predictions. For example, the RNN model may comprise a long short-term memory (LSTM) model. Other types of neural network models, including other deep learning models of various types, may additionally or alternatively be used in illustrative embodiments.

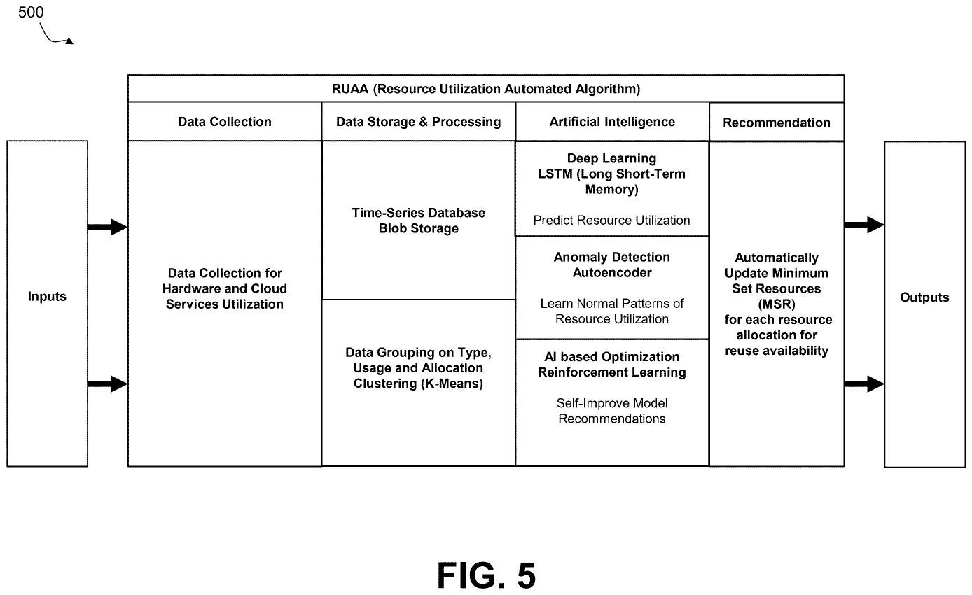

Some embodiments implement a multiple machine learning model arrangement in the machine learning system 116. For example, in addition to the above-noted LSTM model or other RNN model configured to generate the one or more predictions, the machine learning system 116 in some embodiments can include an autoencoder configured to detect anomalies in resource utilization patterns of at least a subset of the users within the enterprise and/or a reinforcement learning model configured to dynamically adjust one or more features of the shared resource pool over time. A more detailed example arrangement of multiple machine learning models that may be implemented in the machine learning system 116 will be described below in conjunction with FIG. 5. Other types and arrangements of additional or alternative machine learning models can be used in other embodiments.

In some embodiments, the automated resource sharing system 112 of the pool hub 110 is further configured to determine a dynamic minimum set of resources for each of at least a subset of the users within the enterprise. In one or more such embodiments, automatically controlling movement of at least portions of the cloud resources into and out of the shared resource pool of the enterprise based at least in part on the one or more predictions comprises automatically controlling movement of at least portions of the cloud resources into and out of the shared resource pool based at least in part on the dynamic minimum set of resources determined for each of at least a subset of the users. The minimum set of resources in such an embodiment is referred to herein as “dynamic” as it illustratively changes over time, for example, under the control of one or more logic instances in the automated resource sharing system 112 of the pool hub 110, in a manner that is at least partly responsive to varying resource utilization by enterprise users.

Additionally or alternatively, automatically controlling movement of at least portions of the cloud resources into and out of the shared resource pool of the enterprise illustratively comprises pushing a first portion of the cloud resources into the pool hub 110 providing the shared resource pool responsive to monitored utilization of the cloud resources by at least one of the users being below a first threshold, and pulling a second portion of the cloud resources out of the pool hub 110 providing the shared resource pool responsive to monitored utilization of the cloud resources by at least one of the users being above a second threshold. Such “pushing” and “pulling” as those terms are broadly used herein with reference to particular resources should be understood as encompassing movement of identifiers or other information characterizing the resources, rather than the resources themselves. For example, particular cloud resources can be included in the shared resource pool by including identifiers or other information characterizing those cloud resources into one or more data structures that define the resources of the shared resource pool.

In some embodiments, at least one of the first and second thresholds is established for a given one of the users based at least in part on a current value of a dynamic minimum set of resources determined for the given user, wherein the dynamic minimum set of resources is determined for the given user at least in part from the one or more predictions generated by the one or more machine learning models.

The automated resource sharing system 112 in some embodiments is further configured to perform one or more preprocessing operations on at least portions of the one or more data structures prior to applying preprocessed portions of the one or more data structures to the one or more machine learning models of the machine learning system 116. For example, in some embodiments, the one or more preprocessing operations comprise performing data grouping utilizing at least one clustering algorithm. Other types of preprocessing operations can be implemented in other embodiments. As indicated above, preprocessed data from the one or more data structures is assumed to comprise at least a portion of the one or more data structures as those terms are broadly used herein.

Additional examples of illustrative automated resource sharing arrangements of the type described above will now be presented. One or more of these aspects are illustratively implemented in the automated resource sharing system 112 of the pool hub 110 in illustrative embodiments. For example, some of these embodiments implement a resource utilization automated algorithm (RUAA), illustratively at least in part within the automated resource sharing system 112 of the pool hub 110, to provide machine learning based automated resource sharing as disclosed herein. At least portions of the RUAA in some embodiments are implemented utilizing the resource utilization data collection logic 114, the machine learning based prediction logic 118 and the machine learning based allocation logic 120.

As mentioned previously, in conventional practice, despite the inherent flexibility of cloud systems, underutilization of resources remains a significant challenge. Many cloud resources, such as storage and virtual machines, often operate below their optimal capacity or are overprovisioned, resulting in wasted resources and increased costs. The automated resource sharing system 112 of the pool hub 110 as disclosed herein advantageously overcomes these and other drawbacks of conventional practice.

The pool hub 110 in some embodiments serves as a central repository which lists all available resources and associated services from all relevant environments of a given enterprise, and based on custom rules defined for the available resources and associated services, illustratively comprising at least VMs and storage resources as well as one or more associated services, can indicate which resources are underutilized and can be shared, used and/or reused. For example, the pool hub 110 illustratively serves as the central repository for all underutilized provisioned resources from multi-cloud and on-premises resources of the public cloud systems 102, the private cloud systems 103 and the on-premises data centers 104.

It should be noted in this regard that the term “on-premises” refers to sharing a common premises with at least a portion of the enterprise. In other words, an on-premises data center is illustratively part of the enterprise itself, while the public and private clouds in some embodiments are assumed to be implemented externally to the enterprise, for use by tenants that include users of the enterprise.

The pool hub 110 in some embodiments implements algorithmic management using the above-noted RUAA. In some embodiments, the RUAA is configured to continuously monitor resource utilization within the system 100 and to control movement of particular cloud resources into and out of the shared resource pool of the pool hub, illustratively including portions of previous resource allocations to one or more users, so as to make those resources available to other users via the pool hub 110. Examples of parameters utilized by the RUAA in illustrative embodiments include one or more of the following:

MSR—Minimum Set Resources is the minimum set of resources allocated to a given group of one or more users, also referred to herein as a “resource group.” Regardless of actual usage and corresponding RUAA values, any underutilized resources from the MSR will not be moved to the shared resource pool of the pool hub 110. A default value for MSR for a given resource group can be determined based at least in part on its actual utilization of resources as reflected in the resource utilization database 111.

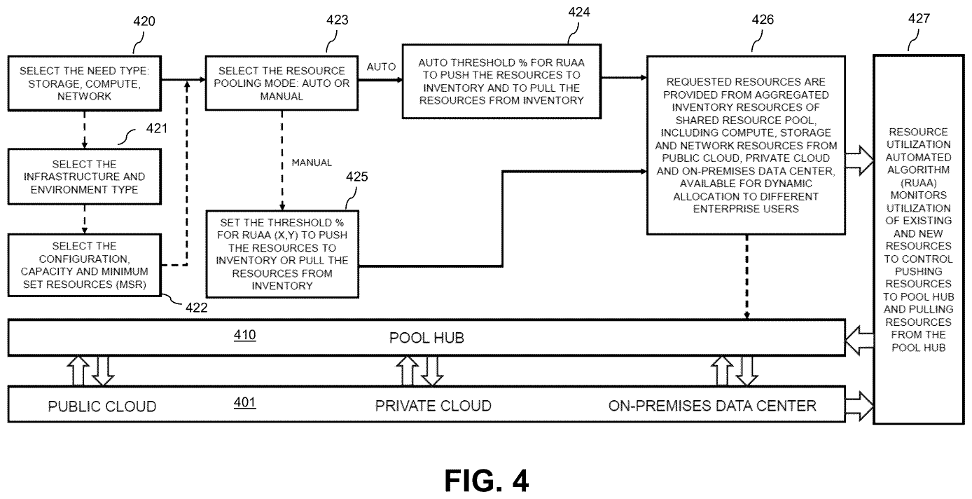

RUAA (x, y)—Threshold set for the RUAA to move resources to and from the shared resource pool of the pool hub 110. For example, in the case of a manual threshold, x is the threshold amount of actual utilization to push the underutilized resources to the shared resource pool from the resource group, and y is the threshold amount of actual utilization to pull the required resources from the shared resource pool to the resource group. As another example, in the case of an automatic threshold, actual utilization of x with 10% reserve allocation based on actual usage is the threshold to push the remaining underutilized resources to the shared resource pool from the resource group working in conjunction with MSR, and actual utilization of y including 10% reserve allocation based on the actual usage working in conjunction with MSR is the threshold to pull the underutilized resources from the shared resource pool to the resource group. Other types of thresholds may be used in other embodiments. Additional examples of possible implementations of RUAA and its associated thresholds are described elsewhere herein, such as in conjunction with FIGS. 4 and 5.

B—Buffer factor to account for potential growth or variations in resource usage, such as storage usage within a given storage tier. The buffer factor allocates a certain amount of additional resources to avoid situations that might otherwise result in resources of a given user being completely utilized.

R—Reuse factor to specify a number of times an existing resource of the shared resource pool of the pool hub 110 can be utilized by a user and then sent back to the shared resource pool as an underutilized resource for potential use by another user. The reuse factor may be specified in terms of a number of reuse cycles.

Some embodiments are configured to provide one or more of the following advantageous features associated with efficient resource utilization, secure sharing and cost savings. These and other embodiments provide a robust ecosystem in which enterprises can maximize utilization of their available cloud resources while minimizing expenses.
1. Resource Sharing Platform. Illustrative embodiments implement the pool hub 110 as a platform that facilitates resource sharing within an enterprise that utilizes multiple distinct cloud systems. This platform allows underutilized resources of the multiple distinct cloud systems that are already allocated to particular enterprise users to be made available to other enterprise users. By adopting this approach, enterprises can optimize their resource allocation, reduce costs and enhance overall efficiency.
2. Identifying Underutilized Resources. To achieve efficient resource utilization, illustrative embodiments implement algorithms, such as the above-noted RUAA, and associated heuristics, in the automate resource sharing system 112 of the pool hub 110. These tools help to identify resources, such as storage, compute and/or network resources, that are operating below their optimal capacity. For instance, consider a scenario where multiple teams maintain separate DBs with varying resource allocations. Algorithms such as the RUAA implemented in the automated resource sharing system 112 of the pool hub 110 can pinpoint which resources are not fully utilized, and push those resources to the shared resource pool, thereby allowing other enterprise users to tap into these unused resource capacities.
3. Cost Savings through Ecosystem Combination. Consider an organization with teams A, B and C, each having a 1 terabyte (TB) storage system. However, further assume that these storage systems are each utilized at less than or equal to 50% capacity. When Team D requires 200 GB of storage, the total usage from the three teams amounts to no more than 1.5 TB, leaving 1.5 TB of unused storage. Instead of provisioning new resources, Team D can tap into the existing underutilized storage. This saves initial provisioning costs.
4. Resource Reuse and Repooling. Assume the original resources were provisioned for a year, but Team D needs the storage for only two months. In this scenario, after the two months, the 200 GB storage becomes available again in the shared resource pool. This reusability factor further enhances cost savings for the enterprise. The storage can now be allocated to Team E or any other team needing it. By repooling and reusing resources, the pool hub 110 creates a multiplier effect on overall savings.
5. Algorithmic Management. Illustrative embodiments implement an algorithmic approach to manage resource sharing, in some embodiments via the above-noted RUAA. This algorithm illustratively automates the process of identifying underutilized resources, reallocating them and ensuring efficient utilization.

It is to be appreciated that the particular features and functionality described above are examples only. Other embodiments can implement numerous alternative arrangements of a hub sharing mechanism as disclosed herein, for optimizing cloud resource utilization for one or more enterprises.

Illustrative embodiments provide significant advantages over conventional practice. For example, one or more such embodiments provide substantially improved resource utilization, thereby significantly reducing overall system costs.

In some embodiments, the pool hub 110 considers the sharing context and prioritizes underutilized resources for sharing. This approach integrates well with a sharing economy model and the pool hub and its AI-driven RUAA serves to maximize efficiency and cost savings in resource sharing within an enterprise.

Some embodiments provide a resource marketplace where, within an organization or other enterprise, users can share underutilized cloud and on-premises resources across multiple cloud systems accessible to a given enterprise.

Conventional cloud resource management tools often focus on optimization within a single cloud provider. Illustrative embodiments disclosed herein extend beyond provider boundaries, allowing seamless sharing across multiple clouds of different types.

These and other features and advantages of illustrative embodiments as disclosed herein are presented by way of example only, and should not be viewed as limiting in any way. For example, other embodiments need not provide one or more of the features and/or advantages described above and elsewhere herein.

The pool hub 110 in the FIG. 1 embodiment is assumed to be implemented using at least one processing device. Such processing devices can illustratively include particular arrangements of computing, storage and network resources. Each such processing device generally comprises at least one processor and an associated memory, and implements at least portions of one or more functional modules or other logic for controlling certain features of the pool hub 110 as disclosed herein.

Accordingly, at least portions of the automated resource sharing system 112 of the pool hub 110 may be implemented at least in part in the form of software that is stored in at least one memory and executed by at least one processor.

The pool hub 110 and other portions of the information processing system 100 may be implemented using at least one processing platform comprising one or more processing devices each having a processor coupled to a memory. Such a processing platform can be implemented in cloud infrastructure or as part of an enterprise system.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the public cloud systems 102, the private cloud systems 103, the on-premises data centers 104, the pool hub 110 and the resource utilization database 111, or portions or components thereof, to reside in different data centers in different geographic locations. Numerous other distributed implementations are possible. The pool hub 110 itself can also be implemented at least in part in a distributed manner across multiple data centers and/or other cloud systems. The term “pool hub” as used herein is therefore intended to be broadly construed, and its centralized arrangement in some embodiments should be viewed as an example only.

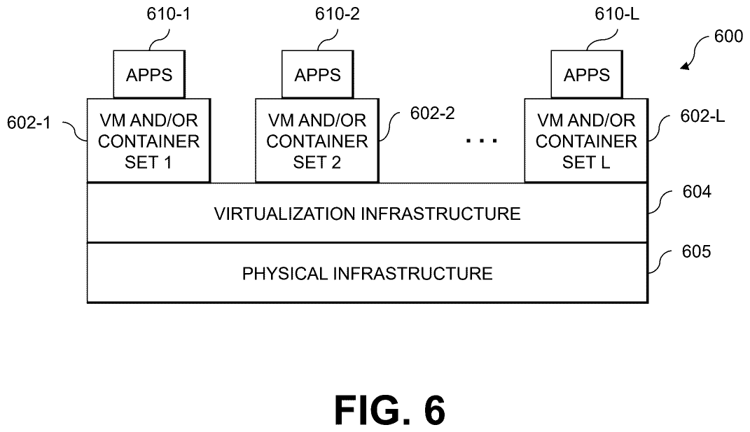

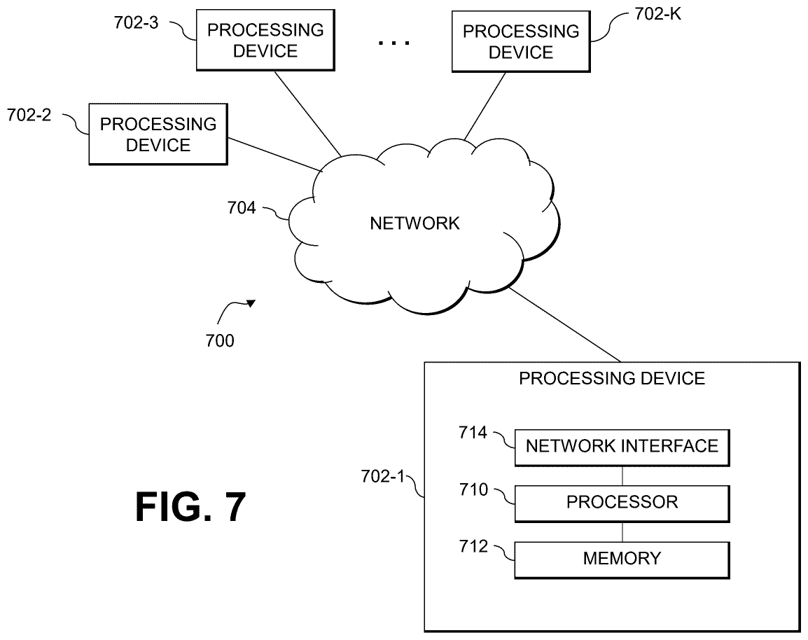

Additional examples of processing platforms utilized to implement the pool hub 110 and other components of the information processing system 100 in illustrative embodiments will be described in more detail below in conjunction with FIGS. 6 and 7.

In some embodiments, a processing platform provides compute, storage and network resources to users under a Platform-as-a-Service (PaaS) model, an Infrastructure-as-a-Service (IaaS) model, a Storage-as-a-Service (SaaS) model and/or a Function-as-a-Service (FaaS) model, although it is to be appreciated that numerous other at least partially cloud-based infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide support services to users as disclosed herein.

It is to be appreciated that the particular arrangement of system components including the public cloud systems 102, private cloud systems 103, on-premises data centers 104, network 106, user devices 107, pool hub 110 and resource utilization database 111, as illustrated in the FIG. 1 embodiment, is presented by way of example only, and a wide variety of alternative arrangements can be used in other embodiments. For example, the resource utilization database 111 in some embodiments may be deployed within the pool hub 110, rather than separate from the pool hub 110 as shown in the figure.

Also, other embodiments may include additional or alternative systems, devices and other network entities, as well as different arrangements of modules and other components. It is therefore to be appreciated that these and other features of FIG. 1 and other illustrative embodiments disclosed herein are presented by way of example only, and should not be construed as limiting in any way.

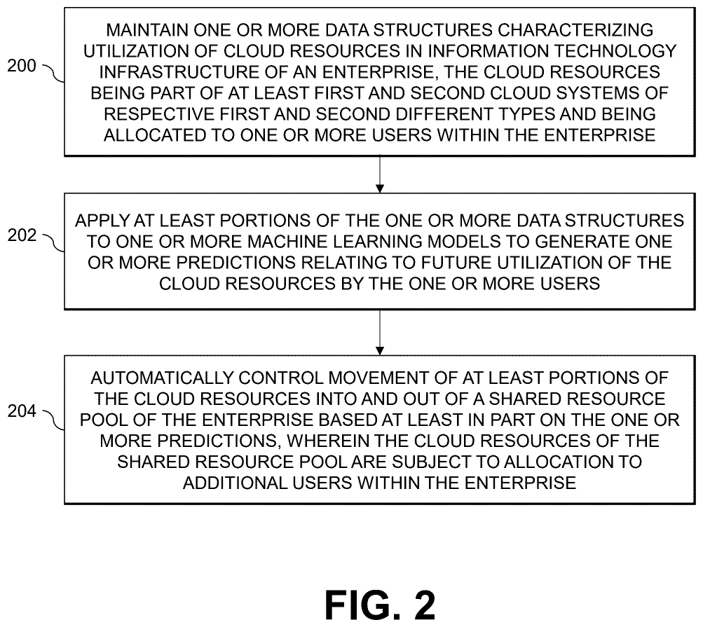

An exemplary process for machine learning based automated resource sharing will now be described in more detail with reference to the flow diagram of FIG. 2. It is to be understood that this particular process is only an example, and that additional or alternative processes for machine learning based automated resource sharing may be used in other embodiments.

In this embodiment, the example process includes steps 200 through 204. These steps are assumed to be performed by the pool hub 110 utilizing the automated resource sharing system 112, including the resource utilization data collection logic 114 and the machine learning system 116 comprising machine learning based prediction logic 118 and machine learning based allocation logic 120, as well as multiple associated machine learning models that may include one or more machine learning models internal to the pool hub 110 and/or one or more machine learning models external to the pool hub 110. Similar processes may be performed utilizing additional or alternative system components in other embodiments.

In step 200, one or more data structures are maintained characterizing utilization of cloud resources in IT infrastructure of an enterprise, the cloud resources being part of at least first and second cloud systems of respective first and second different types and being allocated to one or more users within the enterprise. Such data structures are illustratively maintained at least in part, for example, in the resource utilization database 111. Additionally or alternatively, such data structures may be maintained at least in part within one or more memories or other storage devices of the pool hub 110.

In step 202, at least portions of the one or more data structures are applied to one or more machine learning models to generate one or more predictions relating to future utilization of the cloud resources by the one or more users. As indicated previously, a portion of a given data structure can include, for example, data extracted or otherwise obtained from the data structure and/or preprocessed data generated from such obtained data.

In step 204, movement of at least portions of the cloud resources into and out of a shared resource pool of the enterprise is controlled based at least in part on the one or more predictions, wherein the cloud resources of the shared resource pool are subject to allocation to additional users within the enterprise. For example, cloud resources can be pulled from one or more enterprise entities into the shared resource pool via the pool hub 110 and pushed from the shared resource pool to one or more enterprise entities via the pool hub 110, illustratively utilizing an algorithm such as the RUAA described elsewhere herein.

The process comprising steps 200 through 204 is illustratively repeated for one or more additional iterations, so as to periodically or continuously update the one or more data structures, the one or more predictions, and the particular resources that are included in the shared resource pool, based at least in part on actual and predicted utilization of those resources. Additionally or alternatively, different instances of the process can operate at least in part in parallel with one another in processing different sets of cloud resources, illustratively involving different sets of users.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

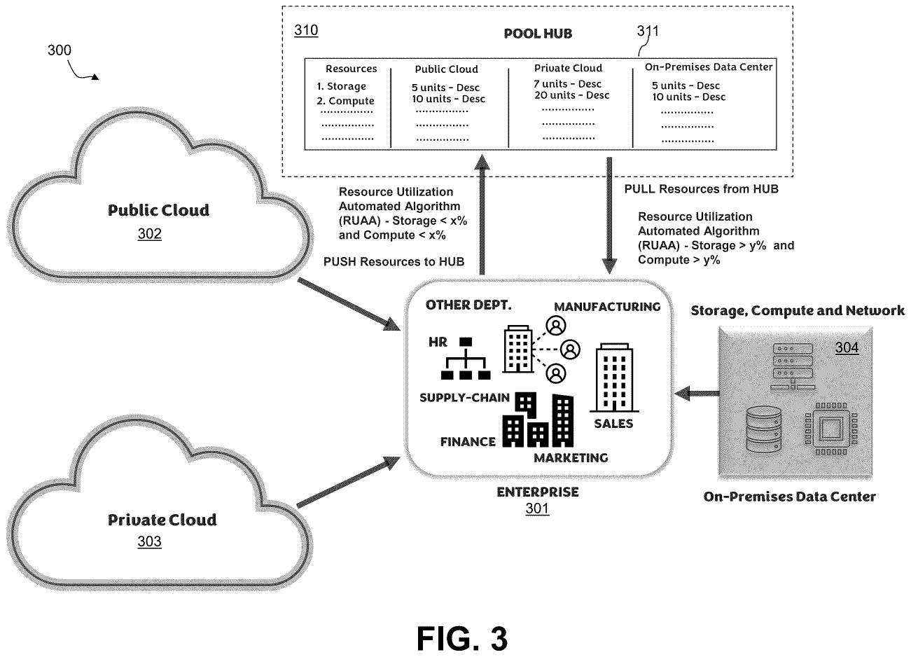

Additional aspects of illustrative embodiments will now be described with reference to FIGS. 3, 4 and 5. Although these embodiments are described in conjunction with particular types of resources and particular automated resource sharing algorithms, the disclosed techniques can be readily adapted for use with additional or alternative resource types and other resource sharing algorithms.

Referring initially to FIG. 3, an information processing system 300 comprises an enterprise 301, a public cloud 302, a private cloud 303, an on-premises data center 304 and a pool hub 310. The enterprise 301 has various entities associated therewith, including teams of users in each of multiple departments, illustratively including sales, marketing, finance manufacturing, supply chain and human resources (HR), as well as others. It is assumed that each of the departments includes one or more resource groups each comprising one or more users that have accessible to them various cloud resources of one or more of the public cloud 302, the private cloud 303 and the on-premises data center 304, such as storage, compute and network resources.

The pool hub 310 in this embodiment implements an RUAA of the type previously described, with a push threshold x and a pull threshold y established for each of the resource groups. For example, the push threshold x indicates a resource utilization level below which resources are pushed from the corresponding enterprise entity to the pool hub 310. Similarly, the pull threshold y indicates a resource utilization level above which resources are pulled from the pool hub 310 to the corresponding enterprise entity. In this embodiment, the cloud resources include storage and compute resources, each of which is illustratively subject to the same push threshold x and pull threshold y. In other embodiments, different thresholds may be established for pushing and pulling different types of resources. For example, push thresholds x1 and x2 may be established in the RUAA for pushing respective storage and compute resources, and pull thresholds y1 and y2 may be established in the RUAA for pulling respective storage and compute resources. Numerous other arrangements of cloud resources and associated push and pull thresholds may be used in other embodiments.

The RUAA in some embodiments is implemented at least in part within the pool hub 310, but may include one or more components, such as data collection components, that are deployed in the public cloud 302, private cloud 303 and on-premises data center 304. The pool hub 310 further maintains a data structure 311 that characterizes the cloud resources of the shared resource pool. For example, the data structure 311 indicates, for each of storage and compute resources, particular units thereof that are available from the public cloud 302, the private cloud 303 and the on-premises data center 304, as well as corresponding descriptions. Other types and arrangements of data structures may be used to characterize the shared resource pool in other embodiments. Also, references to “pushing” or “pulling” resources to or from the shared resource pool of the pool hub 310 should be understood as encompassing arrangements in which the data structure 311 is updated with identifiers or other information characterizing the currently-available resources of the shared resource pool.

FIG. 4 is a combined block diagram and flow diagram showing example operations performed in implementing machine learning based resource sharing in an illustrative embodiment. An information processing system in this embodiment includes an enterprise 401 that utilizes cloud resources of a public cloud, a private cloud and an on-premises data center as illustrated. The information processing system further comprises a pool hub 410 that is in communication with the public cloud, private cloud and on-premises data center of the enterprise 401. The pool hub 410 illustratively controls performance of steps 420 through 427 as shown, utilizing an RUAA of the type previously described.

In step 420, an enterprise user via interaction with a user interface of the pool hub 410 selects the need type for a given resource request. The need type may be, for example, any combination of storage, compute and network resources, and possibly additional or alternative resources in other embodiments. In some embodiments, the enterprise user may be an administrator that is tasked with establishing parameters of a shared resource pool for one or more other users.

Optional steps 421 and 422 allow the user to select additional characteristics for the resource request, such as infrastructure and/or environment type in step 421 and configuration capacity and/or MSR in step 422. These characteristics in other embodiments can be automatically determined by the pool hub 410 and its RUAA.

In step 423, the user via interaction with the above-noted user interface of the pool hub 410 selects a resource pooling mode, such as an automatic mode or a manual mode. Responsive to selection of the automatic mode, step 424 is executed, and responsive to selection of the manual mode, step 425 is executed.

In step 424, an automatic threshold percentage utilization is utilized by the RUAA responsive to selection of the automatic mode. This automatic threshold percentage is determined by the RUAA in an automated manner based on monitoring of resource utilization, and utilized to push resources to an “inventory” of cloud resources of the pool hub 410 and to pull resources from the inventory of cloud resources of the pool hub 410. The automatic threshold percentage utilization dynamically varies over time, and may include a buffer factor B and reuse factor R as previously described.

In step 425, fixed percentage thresholds x and y are established for use by the RUAA in respectively pushing resources to the inventory of cloud resources of the pool hub 410 and pulling resources from the inventory of cloud resources of the pool hub 410.

In step 426, requested resources are provided from aggregated inventory resources of a shared resource pool, including, by way of example, compute, storage and network resources from public cloud, private cloud and on-premises data center. The resources of the shared resource pool are available for dynamic allocation to different enterprise users.

In step 427, the RUAA monitors utilization of existing and new resources to control the pushing of resources to the shared resource pool of the pool hub 410 and the pulling of resources from the shared resource pool of the pool hub 410.

It is to be appreciated that these particular operations are presented by way of illustrative example only, and should not be viewed as limiting in any way. Numerous other arrangements of additional or alternative operations can be implemented by a pool hub and its associated RUAA in other embodiments.

FIG. 5 shows a more detailed example of one possible implementation of an RUAA of the type described above. An example RUAA 500 receives inputs and generates outputs as shown, and is illustratively implemented within an automated resource sharing system of a pool hub, such as automated resource sharing system 112 of pool hub 110 of the FIG. 1 embodiment, although RUAA 500 in other embodiments can be implemented at least in part externally to its corresponding pool hub. The RUAA 500 in some embodiments is more particularly implemented by resource utilization data collection logic 114, machine learning based prediction logic 118 and machine learning based allocation logic 120. The inputs received by the RUAA 500 in some embodiments comprise inputs that are received from one or more public cloud systems, one or more private cloud systems and one or more on-premises data centers, as well as inputs that are received from at least portions of one or more logic instances of the corresponding pool hub. Similarly, the outputs generated by the RUAA 500 in some embodiments comprise outputs that are sent to one or more public cloud systems, one or more private cloud systems and one or more on-premises data centers, as well as outputs that are sent to at least portions of one or more logic instances of the corresponding pool hub.

The RUAA 500 illustratively comprises four stages as shown, namely, a data collection stage, a data storage and processing stage, an artificial intelligence stage, and a recommendation stage.

The data collection stage illustratively performs data collection for hardware and cloud services utilization, including cloud resources such as storage, compute and network resources. For example, utilities such as psutil, GPUtil, other custom Python library components can be used to collect utilization data for hardware devices, and cloud monitoring tools and application programming interfaces (APIs) can be used to collect utilization data for cloud services.

The data storage and processing stage illustratively stores the collected utilization data using a time-series database and binary large object (“Blob”) storage. Additionally, the data storage and processing stage performs data grouping based on features such as type, usage and allocation, using one or more clustering algorithms, such as K-means clustering. Such clustering can be implemented, for example, using scikit-learn, NumPy, and one or more custom Python libraries. In some embodiments, K-means clustering is used in a hierarchical clustering framework with the following example model parameters:
n_clusters=4
init=k-means++
n_init=20
max_iter=300
Step sizes:
n_clusters=(3, 10, 1)
n_init=(10, 20, 2)
max_iter=(250, 400, 25)

The artificial intelligence stage implements multiple machine learning models, including a deep learning RNN model, such as an LSTM model, configured to predict resource utilization (e.g., using NumPy, TensorFlow, etc.), an anomaly detection autoencoder configured to learn normal patterns of resource utilization (e.g., using scikit-learn, TensorFlow, etc.), and a reinforcement learning model configured to self-improve model recommendations (e.g., using NumPy, TensorFlow, etc.).

The LSTM model in some embodiments learns long-term dependencies characterizing resource utilization of the enterprise and predicts future resource utilization in order to optimize resource allocation. The LSTM model illustratively comprises a time series framework model with multiple layers, including an LSTM layer, a dense layer, a dropout layer and a batch normalization layer. Example parameters for the LSTM model in some embodiments are as follows:
epochs=50
batch_size=64
Learning_rate=0.001
units=128
input shape=timesteps
activation=tanh
recurrent_activation=sigmoid
dropout=0.3
recurrent_dropout=0.2
return_sequences=True
rate_scheduler=True
early_stopping=True
Step sizes:
epochs=Increase by 5
units=Increase by factors of 2
Learning_rate=Decrease by factors of 10
dropout=Increase by 0.1
recurrent_dropout=Increase by 0.1

The anomaly detection autoencoder in some embodiments is configured to avoid any system failures relating to resource allocation and to ensure that MSR values and other parameters are appropriate. For example, it can detect unusually low or high resource utilization or other anomalies. The anomaly detection autoencoder in some embodiments comprises encoder, decoder, dropout and batch normalization layers. Example parameters for the anomaly detection autoencoder in some embodiments are as follows:
Number of Layers=3
Units per Layer (encoder)=[128, 64, 32]
Units per Layer (decoder)=[32, 64, 128]
activation=relu
output_activation=linear
rate (dropout)=0.3
optimizer=Adam
loss=MSE
early_stopping=True
Step sizes:
Number of Layers=Increase by 1
Units per Layer (encoder)=Decrease by factors of 2
Units per Layer (decoder)=Increase by factors of 2

The reinforcement learning in some embodiments provides optimization of the RUAA 500 over time to further improve resource allocation within the enterprise. In some embodiments, the reinforcement learning is implemented using a GridSearchCV framework, with multiple layers including actor, critic, dense and replay buffer layers. Example parameters for the reinforcement learning in some embodiments are as follows:
learning_rate=0.0005
gamma=0.96
batch_size=64
epsilon=1.0 to 0.1
replay_buffer_size=50000
target_update_freq=10
episodes=500
reward_function: based on resource saving
Step sizes:
Learning Rate=Decrease by factors of 2
gamma=Increment by 0.01
Batch Size=Increase by factors of 2
Epsilon decay=Increment by factor of 0.95
Replay Buffer Size=Increase by factors of 5

It is to be appreciated that the machine learning models and their associated parameters provided above are examples only, and other embodiments can utilize additional or alternative machine learning models and/or different parameters.

The recommendation stage automatically generates recommendations relating to movement of cloud resources into and out of the shared resource pool of the pool hub, based on results generated by the machine learning models of the artificial intelligence stage. For example, as illustrated, the recommendation stage can automatically update MSR values for each of a plurality of resource allocations in order to update reuse availability. These and other recommendations are utilized to generate outputs of the RUAA 500, which illustratively include instructions to move particular cloud resources into the shared resource pool of the pool hub and to move other particular cloud resources out of the shared resource pool of the pool hub. Such instructions are illustratively utilized by the pool hub to update one or more data structures characterizing the current resources of the shared resource pool, such as the example data structure 311 in the embodiment of FIG. 3. Such data structures maintained by the pool hub illustratively provide a “ledger” of all of the cloud resources within the enterprise that are available for sharing and reuse.

Again, the forgoing arrangements are just examples, and should not be construed as limiting in any way. For example, additional or alternative steps can be used in other embodiments, possibly arranged in an order different than that shown above, and certain steps although arranged serially above may instead at least partially overlap with one another in other embodiments.

It is to be appreciated that the particular functionality, features and advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning based automated resource sharing will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems. The VMs can implement at least portions of the automated resource sharing system 112 of pool hub 110 in illustrative embodiments.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such containers can implement at least portions of the automated resource sharing system 112 of pool hub 110 in illustrative embodiments.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure. It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning based automated resource sharing as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, pool hubs, logic instances, machine learning models, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to maintain one or more data structures characterizing utilization of cloud resources in information technology infrastructure of an enterprise, the cloud resources being part of at least first and second cloud systems of respective first and second different types and being allocated to one or more users within the enterprise;
to apply at least portions of the one or more data structures to one or more machine learning models to generate one or more predictions relating to future utilization of the cloud resources by the one or more users;
to automatically control movement of at least portions of the cloud resources into and out of a shared resource pool of the enterprise based at least in part on the one or more predictions, wherein the cloud resources of the shared resource pool are subject to allocation to additional users within the enterprise.

2. The apparatus of claim 1 wherein the one or more machine learning models comprise at least one recurrent neural network (RNN) model configured to generate the one or more predictions.

3. The apparatus of claim 2 wherein the RNN model comprises a long short-term memory (LSTM) model.

4. The apparatus of claim 1 wherein the one or more machine learning models comprise an autoencoder configured to detect anomalies in resource utilization patterns of at least a subset of the users within the enterprise.

5. The apparatus of claim 1 wherein the one or more machine learning models comprise a reinforcement learning model configured to dynamically adjust one or more features of the shared resource pool over time.

6. The apparatus of claim 1 wherein the at least one processing device is further configured to determine a dynamic minimum set of resources for each of at least a subset of the users within the enterprise, and wherein automatically controlling movement of at least portions of the cloud resources into and out of the shared resource pool of the enterprise based at least in part on the one or more predictions comprises automatically controlling movement of at least portions of the cloud resources into and out of the shared resource pool based at least in part on the dynamic minimum set of resources determined for each of at least a subset of the users.

7. The apparatus of claim 1 wherein the first and second cloud systems of respective first and second different types comprise respective public and private cloud systems of the enterprise.

8. The apparatus of claim 7 wherein the at least first and second cloud systems further comprise a third cloud system of a third type different than the first and second types, the third cloud system comprising at least one on-premises data center of the enterprise.

9. The apparatus of claim 1 wherein automatically controlling movement of at least portions of the cloud resources into and out of a shared resource pool of the enterprise further comprises:
pushing a first portion of the cloud resources into a pool hub providing the shared resource pool responsive to monitored utilization of the cloud resources by at least one of the users being below a first threshold; and
pulling a second portion of the cloud resources out of a pool hub providing the shared resource pool responsive to monitored utilization of the cloud resources by at least one of the users being above a second threshold.

10. The apparatus of claim 9 wherein at least one of the first and second thresholds is established for a given one of the users based at least in part on a current value of a dynamic minimum set of resources determined for the given user, wherein the dynamic minimum set of resources is determined for the given user at least in part from the one or more predictions generated by the one or more machine learning models.

11. The apparatus of claim 1 wherein the at least one processing device is further configured to perform one or more preprocessing operations on at least portions of the one or more data structures prior to applying preprocessed portions of the one or more data structures to the one or more machine learning models, wherein the one or more preprocessing operations comprise performing data grouping utilizing at least one clustering algorithm.

12. A computer program product comprising a non-transitory processor-readable storage medium having stored therein program code of one or more software programs, wherein the program code when executed by at least one processing device causes the at least one processing device:
to maintain one or more data structures characterizing utilization of cloud resources in information technology infrastructure of an enterprise, the cloud resources being part of at least first and second cloud systems of respective first and second different types and being allocated to one or more users within the enterprise;
to apply at least portions of the one or more data structures to one or more machine learning models to generate one or more predictions relating to future utilization of the cloud resources by the one or more users;
to automatically control movement of at least portions of the cloud resources into and out of a shared resource pool of the enterprise based at least in part on the one or more predictions, wherein the cloud resources of the shared resource pool are subject to allocation to additional users within the enterprise.

13. The computer program product of claim 12 wherein the one or more machine learning models comprise at least one recurrent neural network (RNN) model configured to generate the one or more predictions.

14. The computer program product of claim 12 wherein the one or more machine learning models comprise an autoencoder configured to detect anomalies in resource utilization patterns of at least a subset of the users within the enterprise.

15. The computer program product of claim 12 wherein the one or more machine learning models comprise a reinforcement learning model configured to dynamically adjust one or more features of the shared resource pool over time.

16. A method comprising:
maintaining one or more data structures characterizing utilization of cloud resources in information technology infrastructure of an enterprise, the cloud resources being part of at least first and second cloud systems of respective first and second different types and being allocated to one or more users within the enterprise;
applying at least portions of the one or more data structures to one or more machine learning models to generate one or more predictions relating to future utilization of the cloud resources by the one or more users;
automatically controlling movement of at least portions of the cloud resources into and out of a shared resource pool of the enterprise based at least in part on the one or more predictions, wherein the cloud resources of the shared resource pool are subject to allocation to additional users within the enterprise;
wherein the method is performed by at least one processing device comprising a processor coupled to a memory.

17. The method of claim 16 further comprising determining a dynamic minimum set of resources for each of at least a subset of the users within the enterprise, and wherein automatically controlling movement of at least portions of the cloud resources into and out of the shared resource pool of the enterprise based at least in part on the one or more predictions comprises automatically controlling movement of at least portions of the cloud resources into and out of the shared resource pool based at least in part on the dynamic minimum set of resources determined for each of at least a subset of the users.

18. The method of claim 16 wherein automatically controlling movement of at least portions of the cloud resources into and out of a shared resource pool of the enterprise further comprises:
pushing a first portion of the cloud resources into a pool hub providing the shared resource pool responsive to monitored utilization of the cloud resources by at least one of the users being below a first threshold; and
pulling a second portion of the cloud resources out of a pool hub providing the shared resource pool responsive to monitored utilization of the cloud resources by at least one of the users being above a second threshold.

19. The method of claim 18 wherein at least one of the first and second thresholds is established for a given one of the users based at least in part on a current value of a dynamic minimum set of resources determined for the given user, wherein the dynamic minimum set of resources is determined for the given user at least in part from the one or more predictions generated by the one or more machine learning models.

20. The method of claim 16 further comprising performing one or more preprocessing operations on at least portions of the one or more data structures prior to applying preprocessed portions of the one or more data structures to the one or more machine learning models, wherein the one or more preprocessing operations comprise performing data grouping utilizing at least one clustering algorithm.
